(19) United States
(12) Patent Application Publication
(10) Pub. No.: US 2014/0100847 A1
(43) Pub. Date: Apr. 10, 2014

(54) VOICE RECOGNITION DEVICE AND NAVIGATION DEVICE

(71) Applicants: Jun Ishii, Tokyo (JP); Michihiro Yamazaki, Tokyo (JP)

(72) Inventors: Jun Ishii, Tokyo (JP); Michihiro Yamazaki, Tokyo (JP)

(73) Assignee: MITSUBISHI ELECTRIC CORPORATION, Tokyo (JP)

(21) Appl. No.: 14/117,830

(22) PCT Filed: Jul. 5, 2011
(86) PCT No.: PCT/JP2011/003827

§ 371 Date: Nov. 14, 2013

(51) Int. Cl. G10L 15/32

(52) U.S. Cl. CPC G10L 15/32
USPC 704/236

(57) ABSTRACT

Disclosed is a voice recognition device including: first through Mth voice recognition parts each for detecting a voice interval from sound data stored in a sound data storage unit 2 to extract a feature quantity of the sound data within the voice interval, and each for carrying out a recognition process on the basis of the feature quantity extracted thereby while referring to a recognition dictionary; a voice recognition switching unit 4 for switching among the first through Mth voice recognition parts; a recognition control unit 5 for controlling the switching among the voice recognition parts by the voice recognition switching unit 4 to acquire recognition results acquired by a voice recognition part selected; and a recognition result selecting unit 6 for selecting a recognition result to be presented to a user from the recognition results acquired by the recognition control unit 5.

### FIELD OF THE INVENTION

The present invention relates to a voice recognition device and a navigation device equipped with this voice recognition device.

### BACKGROUND OF THE INVENTION

A currently-used car navigation device typically has a voice input I/F and a function of carrying out voice recognition on an address or a facility name uttered by the user. However, there is a case in which it is difficult to set a large-size vocabulary, such as addresses and facility names, as objects to be recognized at one time because of restrictions imposed on the work memory and the computing power of hardware which is installed as a car navigation device, and a problem with the recognition rate.

To solve this problem, patent reference 1 discloses a voice recognition device that divides a target for voice recognition into parts, and divides a recognition process into plural steps to carry out the steps on the parts, respectively. This device divides the target for voice recognition into parts and carries out voice recognition on the parts in turn, and, when the recognition score (likelihood) of a recognition result is equal to or higher than a threshold, decides the recognition result and ends the processing. In contrast, when there is no recognition result whose recognition score is equal to or higher than the above-mentioned threshold, the device determines a recognition result having the highest recognition score among the recognition results which the device has acquired as a final recognition result. By thus dividing the target for voice recognition into parts, the device can prevent a reduction in the recognition rate. Further, because the device ends the processing when the recognition score of a recognition result becomes equal to or higher than the threshold, the device can shorten the time required to carry out the recognition processing.

### RELATED ART DOCUMENT

### Patent reference

Patent reference 1: Japanese Unexamined Patent Application Publication No. 2009-230068

### SUMMARY OF THE INVENTION

### Problems to be Solved by the Invention

In a conventional technology represented by patent reference 1, for example, when recognition is carried out on a target by sequentially performing different voice recognition processes, such as a syntax-based one and a dictation-based one, a simple comparison between the recognition scores (likelihood) of the recognition results cannot be made. Therefore, a problem is that when there is no recognition result whose recognition score is equal to or higher than the above-mentioned threshold, a recognition result having the highest recognition score among the recognition results which have been acquired cannot be selected, and hence no recognition result can be presented to the user.

The present invention is made in order to solve the above-mentioned problem, and it is therefore an object of the present invention to provide a voice recognition device that can exactly present recognition results acquired through different voice recognition processes, and can achieve a reduction in the time required to carry out the recognition processing, and a navigation device equipped with this voice recognition device.

### Means for Solving the Problem

In accordance with the present invention, there is provided a voice recognition device including: an acquiring unit that carries out digital conversion on an inputted sound to acquire sound data; a sound data storage that stores the sound data which the acquiring unit acquires; a plurality of voice recognizers each of that detects a voice interval from the sound data stored in the sound data storage to extract a feature quantity of the sound data within the voice interval, and each of that carries out a recognition process on the basis of the feature quantity extracted thereby while referring to a recognition dictionary; a switch that switching among the plurality of voice recognizers; a controller that controls the switching among the voice recognizers by the switch to acquire recognition results acquired by a voice recognizer selected; and a selector that selects a recognition result to be presented to a user from the recognition results acquired by the controller.

### Advantages of the Invention

According to the present invention, there is provided an advantage of being able to exactly present recognition results acquired through different voice recognition processes, and achieve a reduction in the time required to carry out the recognition processing.

### BRIEF DESCRIPTION OF THE FIGURES

FIG. 1 is a block diagram showing the structure of a navigation device equipped with a voice recognition device according to Embodiment 1 of the present invention;

FIG. 2 is a flow chart showing a flow of a voice recognition process carried out by the voice recognition device in accordance with Embodiment 1;

FIG. 3 is a diagram showing an example of a display of a recognition result having a first ranked recognition score and a recognition result having a second ranked recognition score which are acquired by each of voice recognition units;

FIG. 4 is a diagram showing an example of a display of recognition results which are selected by using a different method for each voice recognition unit;

FIG. 5 is a block diagram showing the structure of a voice recognition device according to Embodiment 2 of the present invention;

FIG. 6 is a block diagram showing the structure of a voice recognition device according to Embodiment 3 of the present invention;

FIG. 7 is a flow chart showing a flow of a voice recognition process carried out by the voice recognition device in accordance with Embodiment 3;

FIG. 8 is a block diagram showing the structure of a voice recognition device according to Embodiment 4 of the present invention;

FIG. 9 is a flow chart showing a flow of a voice recognition process carried out by the voice recognition device in accordance with Embodiment 4;

FIG. 10 is a block diagram showing the structure of a voice recognition device according to Embodiment 5 of the present invention; and

FIG. 11 is a flow chart showing a flow of a voice recognition process carried out by the voice recognition device in accordance with Embodiment 5.

### EMBODIMENTS OF THE INVENTION

Hereafter, in order to explain this invention in greater detail, the preferred embodiments of the present invention will be described with reference to the accompanying drawings. Embodiment 1.

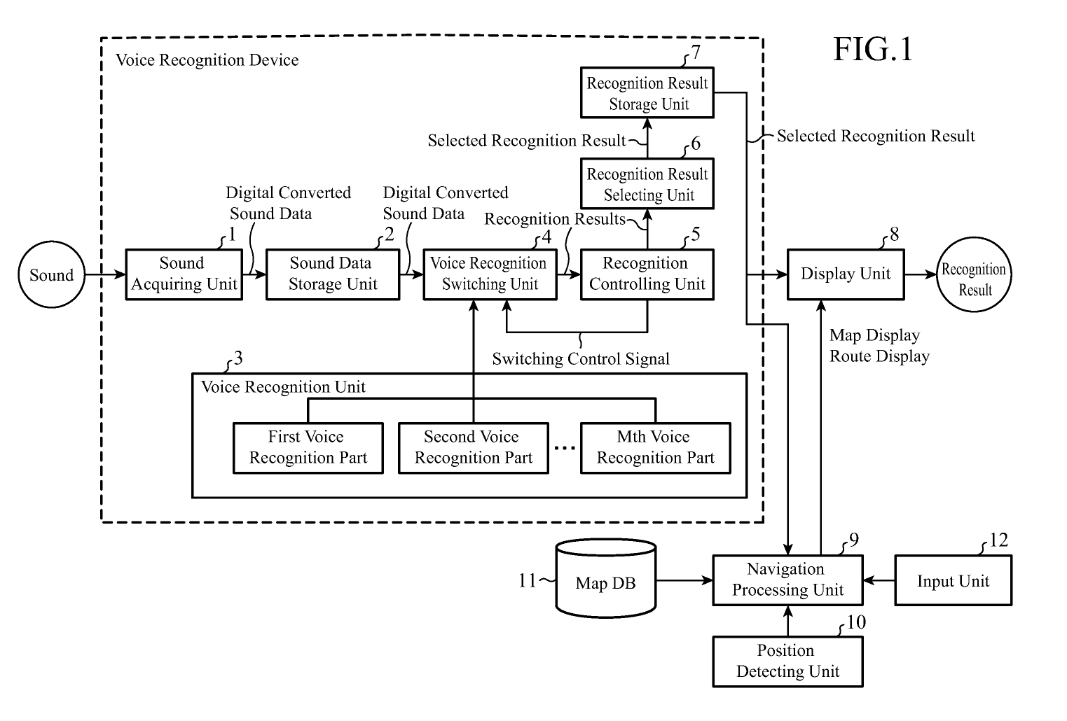

FIG. 1 is a block diagram showing the structure of a navigation device equipped with a voice recognition device in accordance with Embodiment 1 of the present invention. The navigation device in accordance with Embodiment 1 shown in FIG. 1 is an example of applying the voice recognition device in accordance with Embodiment 1 to a vehicle-mounted navigation device mounted in a vehicle which is a moving object. The navigation device is provided with a sound acquiring unit 1, a sound data storage unit 2, a voice recognition unit 3, a voice recognition switching unit 4, a recognition controlling unit 5, a recognition result selecting unit 6, and a recognition result storage unit 7 as components of the voice recognition device, and is provided with a display unit 8, a navigation processing unit 9, a position detecting unit 10, a map database (DB) 11, and an input unit 12 as components used for carrying out navigation.

The sound acquiring unit 1 carries out analog-to-digital conversion on a sound received within a predetermined time interval which is inputted thereto via a microphone or the like to acquire sound data in a certain form, e.g., a PCM (Pulse Code Modulation) form. The sound data storage unit 2 stores the sound data acquired by the sound acquiring unit 1. The voice recognition unit 3 consists of a plurality of voice recognition parts (referred to as first through Mth voice recognition parts from here on) each for carrying out a different voice recognition process, such as a syntax-based one or a dictation-based one. Each of the first through Mth voice recognition parts detects a voice interval corresponding to a description of a user's utterance from the sound data which the sound acquiring unit 1 has acquired according to a voice recognition algorithm thereof, extracts a feature quantity of the sound data within the voice interval, and carries out a recognition process on the sound data on the basis of the feature quantity extracted thereby while referring to a recognition dictionary.

The voice recognition switching unit 4 switches among the first through Mth voice recognition parts according to a switching control signal from the recognition controlling unit 5. The recognition controlling unit 5 controls the switching among the voice recognition parts by the voice recognition switching unit 4, and acquires recognition results acquired by each voice recognition part selected thereby. The recognition result selecting unit 6 selects a recognition result to be outputted from the recognition results which the recognition controlling unit 5 has acquired. The recognition result storage unit 7 stores the recognition result selected by the recognition result selecting unit 6.

The display unit 8 displays the recognition result stored in the recognition result storage unit 7 or a processed result acquired by the navigation processing unit 9. The navigation processing unit 9 is a functional component for carrying out navigation processes, such as route determination, route guidance, and a map display. For example, the navigation processing unit 9 determines a route from a current vehicle position to a destination by using the current position of a vehicle where the position detecting unit 10 has acquired, the destination inputted thereto via the voice recognition device in accordance with Embodiment 1 or the input unit 12, and map data which the map database (DB) 11 stores. The navigation processing unit 9 then carries out route guidance of the route acquired through the route determination. The navigation processing unit 9 also displays a map of an area including the vehicle position on the display unit 8 by using the current position of the vehicle and map data which the map DB 11 stores.

The position detecting unit 10 is a functional component for acquiring the position information about the position of the vehicle (latitude and longitude) from the result of an analysis of GPS (Global Positioning System) radio waves or the like. Further, the Map DB 11 is the one in which the map data used by the navigation processing unit 9 are registered. Topographical map data, residential area map data, road networks are included in the map data. The input unit 12 is a functional component for accepting an input showing a setup of a destination by the user or various operations. For example, the input unit is implemented by a touch panel mounted on the screen of the display unit 8, or the like.

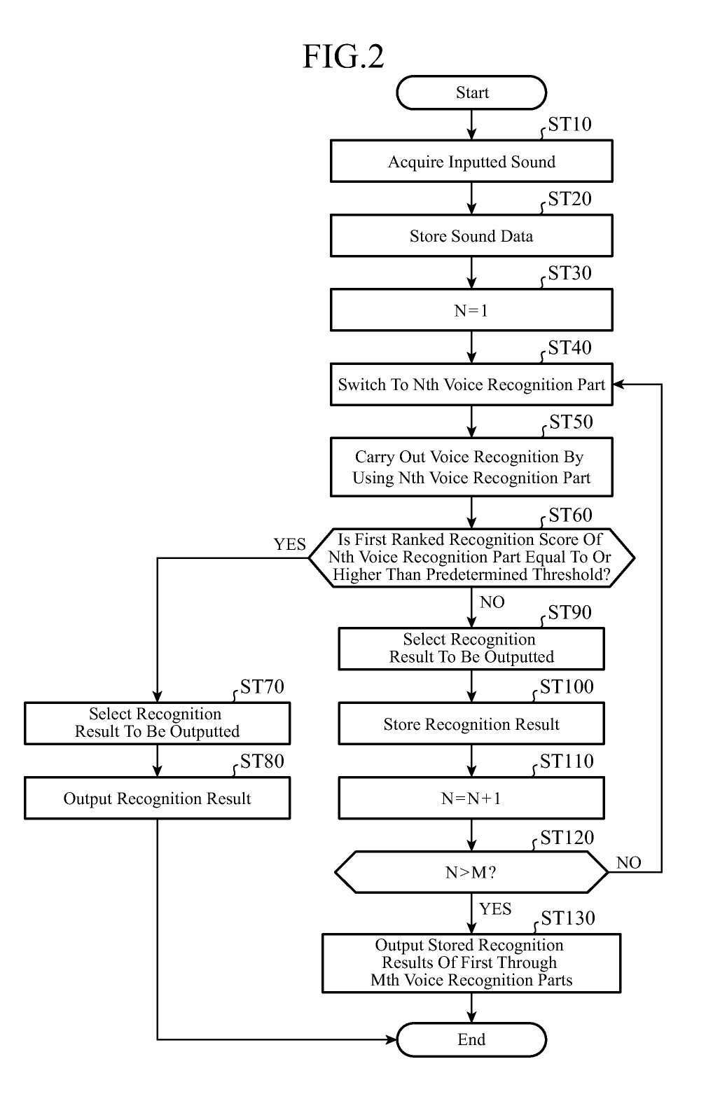

Next, the operation of the navigation device will be explained. FIG. 2 is a flow chart showing a flow of a voice recognition process carried out by the voice recognition device in accordance with Embodiment 1. First, the sound acquiring unit 1 performs A/D conversion on a sound received within a predetermined time interval which is inputted thereto via the microphone or the like to acquire sound data in a certain form, e.g., a PCM form (step ST10). The sound data storage unit 2 stores the sound data acquired by the sound acquiring unit 1 (step ST20).

The recognition controlling unit 5 then initializes a variable N to 1 (step ST30). The variable N can have a value ranging from 1 to M. The recognition controlling unit 5 then outputs a switching control signal to switch the voice recognition unit 3 to the Nth voice recognition part to the voice recognition switching unit 4. The voice recognition switching unit 4 switches the voice recognition unit 3 to the Nth voice recognition part according to the switching control signal from the recognition controlling unit 5 (step ST40).

The Nth voice recognition part detects a voice interval corresponding to a user's utterance from the sound data stored in the sound data storage unit 2, extracts a feature quantity of the sound data within the voice interval, and carries out a recognition process on the sound data on the basis of the feature quantity while referring to the recognition dictionary (step ST50). The recognition controlling unit 5 acquires the recognition results from the Nth voice recognition part, and compares a first ranked recognition score (likelihood) in the recognition scores of the recognition results with a predetermined threshold to determine whether or not the first ranked recognition score is equal to or higher than the threshold (step ST60). The above-mentioned predetermined threshold is used in order to determine whether or not to switch to another voice recognition unit and continue the recognition processing, and is set for each of the first through Mth voice recognition parts.

When the first ranked recognition score is equal to or higher than the above-mentioned threshold (when YES in step ST60), the recognition result selecting unit 6 selects a recognition result to be outputted from the recognition results acquired by the Nth voice recognition part which the recognition controlling unit 5 acquires by using a method which will be mentioned below (step ST70). After that, the display unit 8 displays the recognition result which is selected by the recognition result selecting unit 6 and which is stored in the recognition result storage unit 7 (step ST80). In contrast, when the first ranked recognition score is lower than the above-mentioned threshold (when NO in step ST60), the recognition result selecting unit 6 selects a recognition result to be outputted from the recognition results acquired by the Nth voice recognition part which the recognition controlling unit 5 acquires by using a method which will be mentioned below (step ST90).

The recognition result selecting unit 6 then stores the selected recognition result in the recognition result storage unit 7 (step ST100). When the recognition result selecting unit 6 stores the recognition result in the recognition result storage unit 7, the recognition controlling unit 5 increments the variable N by 1 (step ST110), and determines whether the value of the variable N exceeds the total number M of the voice recognition parts (step ST120).

When the value of the variable N exceeds the total number M of the voice recognition parts (when YES in step ST120), the display unit 8 outputs the recognition results acquired by the first through Mth voice recognition parts stored in the recognition result storage unit 7 (step ST130). The display unit 8 can output the recognition results in order in which the recognition results have been acquired by the plurality of voice recognition parts. When the value of the variable N is equal to or smaller than the total number M of the voice recognition parts (when NO in step ST120), the voice recognition device returns to the process of step ST40. As a result, the voice recognition device repeats the above-mentioned processes by using the voice recognition part to which the voice recognition switching unit switches the voice recognition unit.

Hereafter, steps ST70 and ST90 will be explained by giving a concrete example. The recognition result selecting unit 6 selects a recognition result having a higher score from the recognition results which the recognition controlling unit 5 acquires. For example, the selection method can be the one of selecting a recognition result having a first ranked recognition score, as mentioned above. As an alternative, the selection method can be the one of selecting all the recognition results that the recognition controlling unit 5 acquires. The selection method can be alternatively the one of selecting recognition results including from the recognition result having the first ranked recognition score to a recognition result having an Xth ranked recognition score. As an alternative, the selection method can be the one of selecting one or more recognition results each having a recognition score whose difference with respect to the first ranked recognition score is equal to or smaller than a predetermined value. In addition, a recognition result whose recognition score is lower than a predetermined threshold can be excluded even though the recognition result is included in the recognition results including from the recognition result having the first ranked recognition score to the recognition result having the Xth ranked recognition score or the recognition result is included in the one or more recognition results each having a recognition score whose difference with respect to the first ranked recognition score is equal to or smaller than the predetermined value.

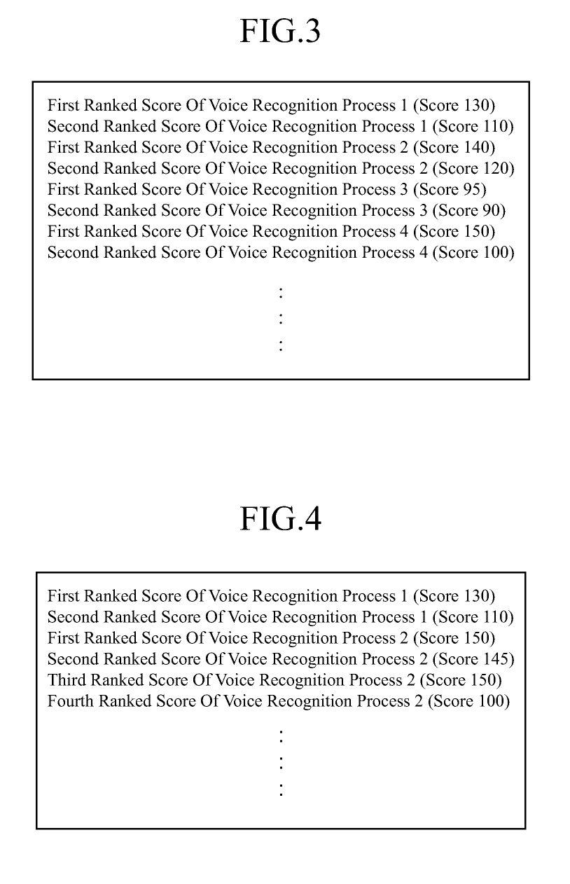

FIG. 3 is a diagram showing an example of a display of a recognition result having a first ranked recognition score and a recognition result having a second ranked recognition score which are acquired by each of the voice recognition parts. In FIG. 3, “voice recognition process 1” denotes a recognition result acquired by the first voice recognition part, for example, and “voice recognition process 2” denotes a recognition result acquired by the second voice recognition part, for example. The same goes for “voice recognition process 3”, “voice recognition process 4”, and . . . . The recognition results including from the one having the first ranked recognition score (likelihood) to the one having the second ranked recognition score (likelihood) are displayed in order for each of the voice recognition parts.

FIG. 4 is a diagram showing an example of a display of recognition results which are selected by using a different method for each of the voice recognition parts. In FIG. 4, for the first voice recognition part (“voice recognition process 1”), the recognition results including from the recognition result having the first ranked recognition score to the recognition result having the second ranked recognition score are selected and displayed. Further, for the second voice recognition part (“voice recognition process 2”), all the recognition results are selected and displayed. Thus, the selection method of selecting recognition results can differ for each of the voice recognition parts in steps ST70 and ST90.

When the user selects a recognition result displayed on the display unit 8 by using, for example, the input unit 12, the voice recognition device reads the result of recognition of the destination uttered by the user from the recognition result storage unit 7 and then outputs the recognition result to the navigation processing unit 9. The navigation processing unit 9 determines a route from the current vehicle position to the destination by using, for example, the current position of the vehicle which the position detecting unit 10 acquires, the result of recognition of the destination read from the recognition result storage unit 7, and map data stored in the map DB 11, and provides route guidance about the route acquired thereby for the user.

As mentioned above, the voice recognition device according to this Embodiment 1 includes: the sound acquiring unit 1 for carrying out digital conversion on an inputted sound to acquire sound data; the sound data storage unit 2 for storing the sound data which the sound acquiring unit 1 acquires; the first through Mth voice recognition parts each for detecting a voice interval from the sound data stored in the sound data storage unit 2 to extract a feature quantity of the sound data within the voice interval, and each for carrying out a recognition process on the basis of the feature quantity extracted thereby while referring to a recognition dictionary; the voice recognition switching unit 4 for switching among the first through Mth voice recognition parts; the recognition controlling unit 5 for controlling the switching among the voice recognition parts by the voice recognition switching unit 4 to acquire recognition results acquired by a voice recognition part selected; and the recognition result selecting unit 6 for selecting a recognition result to be presented to a user from the recognition results acquired by the recognition controlling unit 5. Because the voice recognition device is constructed in this way, even in a case in which a simple comparison between the recognition scores of recognition results cannot be made because the recognition results are acquired through different voice recognition processes, and hence a recognition result having the highest recognition score cannot be determined, the voice recognition device can present a recognition result acquired through each of the voice recognition processes to the user.

### Embodiment 2

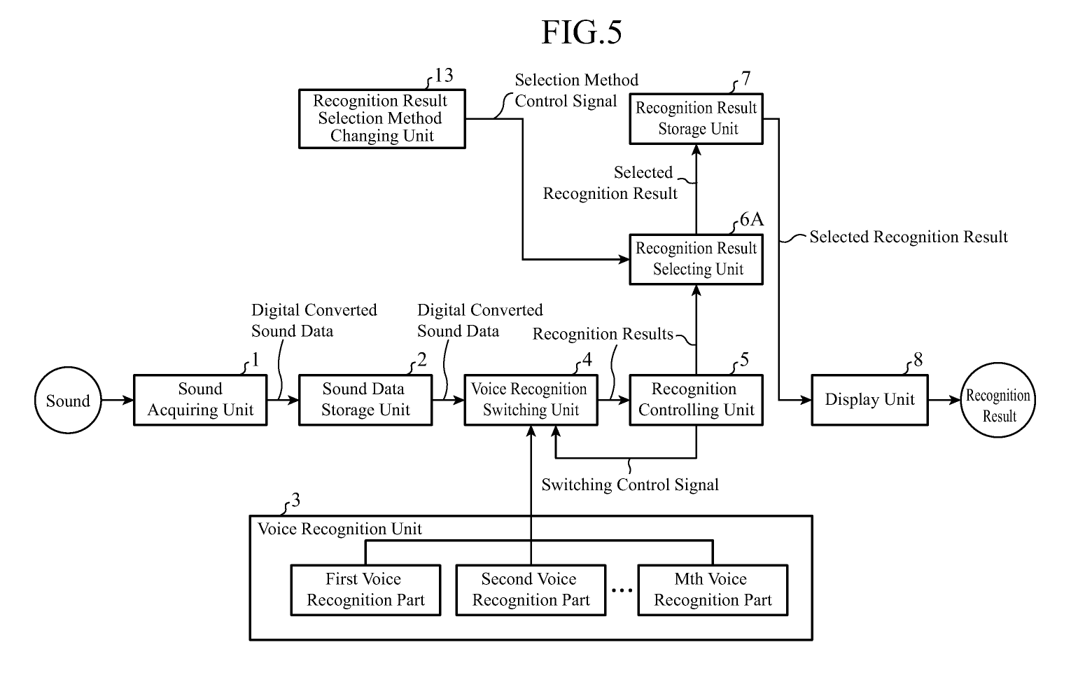

FIG. 5 is a block diagram showing the structure of a voice recognition device in accordance with Embodiment 2 of the present invention. As shown in FIG. 5, the voice recognition device in accordance with Embodiment 2 is provided with a sound acquiring unit 1, a sound data storage unit 2, a voice recognition unit 3, a voice recognition switching unit 4, a recognition controlling unit 5, a recognition result selecting unit 6A, a recognition result storage unit 7, and a recognition result selection method changing unit 13. The recognition result selecting unit 6A selects a recognition result to be outputted from recognition results acquired by the recognition controlling unit 5 according to a selection method control signal from the recognition result selection method changing unit 13. The recognition result selection method changing unit 13 is a functional component responsive to a specification of a selection method of selecting a recognition result, which the recognition result selecting unit 6A uses, for outputting the selection method control signal to change to a selection method specified by a user for each of first through Mth voice recognition parts to the recognition result selecting unit 6A. In FIG. 5, the same components as those shown in FIG. 1 are designated by the same reference numerals, and the explanation of the components will be omitted hereafter.

Next, the operation of the voice recognition device will be explained. The recognition result selection method changing unit 13 displays a screen for specification of a selection method of selecting a recognition result on a display unit 8 to provide an HMI (Human Machine Interface) for accepting a specification by a user. For example, the recognition result selection method changing unit displays a screen for specification which enables the user to bring each of the first through Mth voice recognition parts into correspondence with a selection method through the user's operation. As a result, the recognition result selection method changing unit sets a selection method selected for each of the voice recognition parts to the recognition result selecting unit 6A. The user can specify a selection method for each of the voice recognition parts according to the user's needs, and can also specify a selection method for each of the voice recognition parts according to the usage status of the voice recognition device. In addition, in a case in which a degree of importance is preset to each of the voice recognition parts, the recognition result selection method changing unit can specify a selection method in such a way that a larger number of recognition results are selected from the recognition results acquired by a voice recognition part having a higher degree of importance. The recognition result selection method changing unit can make a setting not to specify any selection method for a certain voice recognition part. More specifically, the recognition result selection method changing unit can make a setting not to output any recognition result acquired by the voice recognition part.

Voice recognition processing carried out by the voice recognition device in accordance with Embodiment 2 is the same as that shown in the flow chart of FIG. 2 explained in above-mentioned Embodiment 1. However, in steps ST70 and ST90, the recognition result selecting unit 6A selects a recognition result according to the selection method which the recognition result selection method changing unit 13 sets. For example, from the recognition results which the recognition controlling unit 5 acquires from a first voice recognition part, the recognition result selecting unit selects a recognition result having a first ranked recognition score, and from the recognition results which the recognition controlling unit 5 acquires from a second voice recognition part, selects all of them. Thus, in accordance with Embodiment 2, the user is enabled to determine a selection method of selecting a recognition result for each of the voice recognition parts. Other processes are the same as those according to above-mentioned Embodiment 1.

As mentioned above, the voice recognition device according to this Embodiment 2 includes the recognition result selection method changing unit 13 for accepting a specification of a selection method of selecting a recognition result to be presented to a user from recognition results which the recognition controlling unit 5 acquires, and for changing the selection method of selecting a recognition result which the recognition result selecting unit 6A uses according to the specified selection method. Because the voice recognition device is constructed in this way, the voice recognition device enables the user to specify the selection method of selecting a recognition result which the recognition result selecting unit 6A uses, and can present the result of a voice recognition process which the user thinks is optimal according to, for example, the usage status thereof to the user.

### Embodiment 3

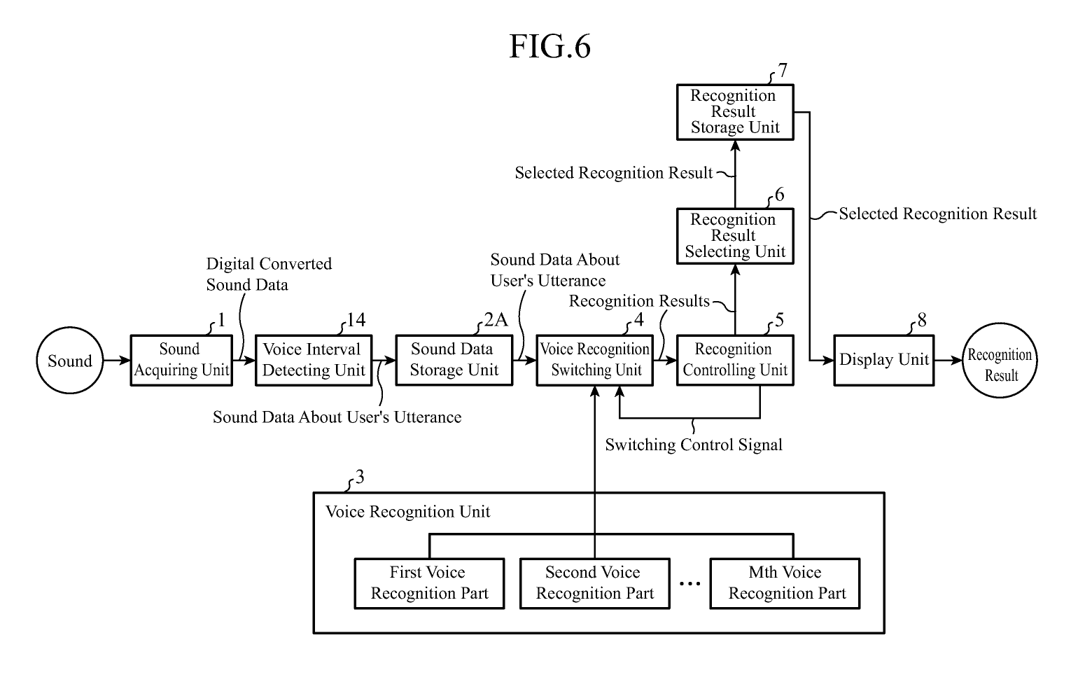

FIG. 6 is a block diagram showing the structure of a voice recognition device in accordance with Embodiment 3 of the present invention. As shown in FIG. 6, the voice recognition device in accordance with Embodiment 3 is provided with a sound acquiring unit 1, a sound data storage unit 2A, a voice recognition unit 3, a voice recognition switching unit 4, a recognition controlling unit 5, a recognition result selecting unit 6, a recognition result storage unit 7, and a voice interval detecting unit 14. In FIG. 6, the same components as those shown in FIG. 1 are designated by the same reference numerals, and the explanation of the components will be omitted hereafter.

The sound data storage unit 2A stores sound data about a sound received within a voice interval which is detected by the voice interval detecting unit 14. Further, the voice interval detecting unit 14 detects sound data about a sound received within a voice interval corresponding to a description of a user's utterance from sound data which the sound acquiring unit 1 acquires. Each of first through Mth voice recognition parts extracts a feature quantity of the sound data stored in the sound data storage unit 2A, and carries out a recognition process on the sound data on the basis of the feature quantity extracted thereby while referring to a recognition dictionary. Thus, in Embodiment 3, each of the first through Mth voice recognition parts does not carry out the voice interval detecting process individually.

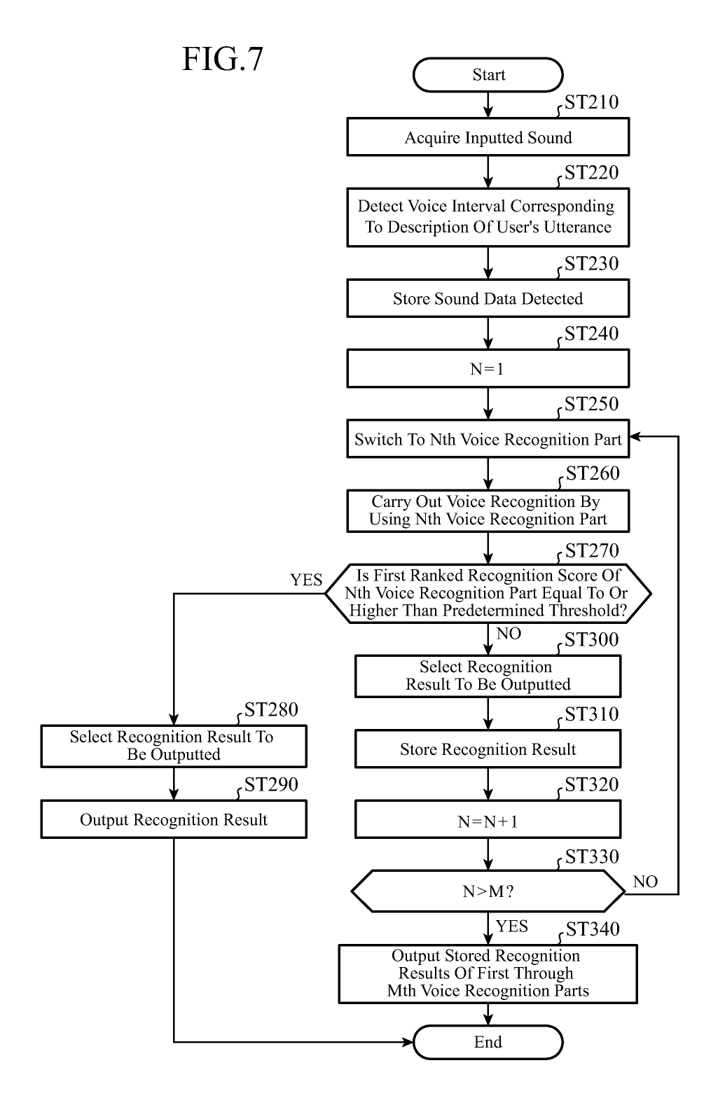

Next, the operation of the voice recognition device will be explained. FIG. 7 is a flow chart in which the flow of the voice recognition process in accordance with the voice recognition device in accordance with Embodiment 3 is shown. First, the sound acquiring unit 1 carries out A/D conversion on a sound received within a certain time interval which is inputted thereto via a microphone or the like to acquire sound data in a certain form, e.g., a PCM form (step ST210). The voice interval detecting unit 14 then detects sound data about a sound received with an interval corresponding to a description of a user's utterance from the sound data which the sound acquiring unit 1 acquires (step ST220). The sound data storage unit 2A stores the sound data detected by the voice interval detecting unit 14 (step ST230).

The recognition controlling unit 5 then initializes a variable N to 1 (step ST240). The recognition controlling unit 5 then outputs a switching control signal to switch the voice recognition unit 3 to the Nth voice recognition part to the voice recognition switching unit 4. The voice recognition switching unit 4 switches the voice recognition unit 3 to the Nth voice recognition part according to the switching control signal from the recognition controlling unit 5 (step ST250).

The Nth voice recognition part extracts a feature quantity from the sound data about a sound received within each voice interval which is stored in the sound data storage unit 2A, and carries out the recognition process on the sound data on the basis of the feature quantity while referring to the recognition dictionary (step ST260). Because processes of subsequent steps ST270 to ST340 are the same as those of steps ST60 to ST130 shown in FIG. 2 of above-mentioned Embodiment 1, the explanation of the processes will be omitted hereafter.

As mentioned above, the voice recognition device according to this Embodiment 3 includes: the sound acquiring unit 1 for carrying out digital conversion on an inputted sound to acquire sound data; the voice interval detecting unit 14 for detecting a voice interval corresponding to a user's utterance from the sound data which the sound acquiring unit 1 acquires; the sound data storage unit 2A for storing sound data about each voice interval which the voice interval detecting unit 14 detects; the first through Mth voice recognition parts each for extracting a feature quantity of the sound data stored in the sound data storage unit 2A, and each for carrying out a recognition process on the basis of the feature quantity extracted thereby while referring to the recognition dictionary; the voice recognition switching unit 4 for switching among the first through Mth voice recognition parts; the recognition controlling unit 5 for controlling the switching among the voice recognition parts by the voice recognition switching unit 4 to acquire recognition results acquired by a voice recognition part selected; and the recognition result selecting unit 6 for selecting a recognition result to be presented to a user from the recognition results which the recognition controlling unit 5 acquires. Because the voice recognition device is constructed in this way, each of the first through Mth voice recognition parts does not carry out the voice interval detection. Therefore, the time required to carry out the recognition process can be reduced.

### Embodiment 4

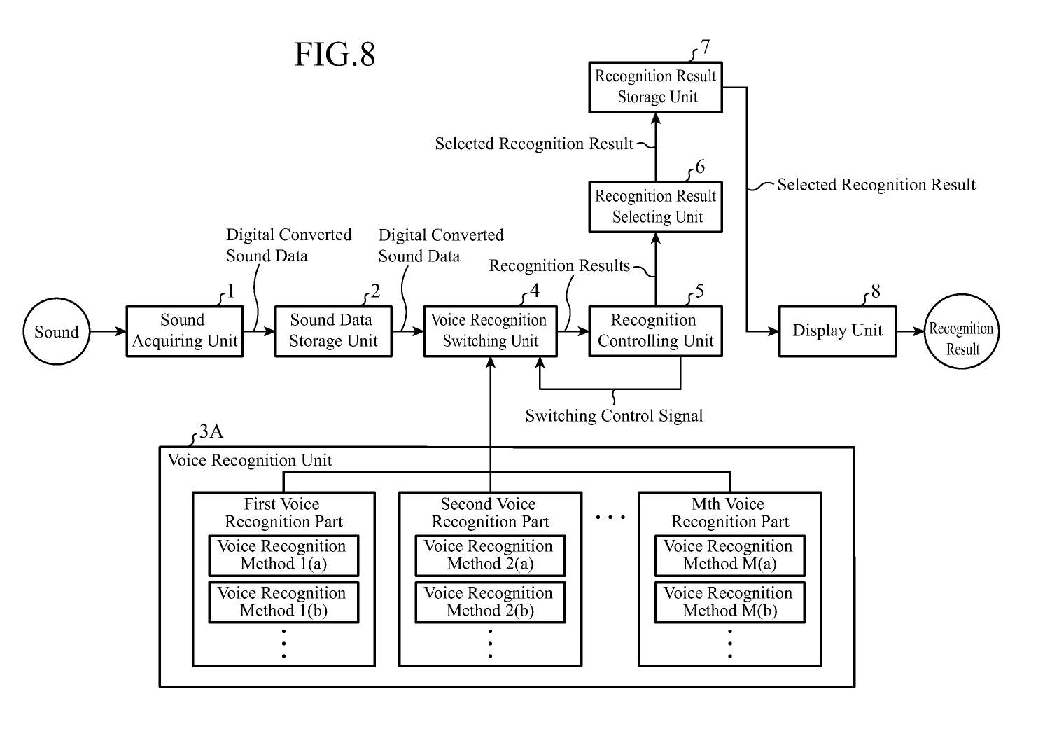

FIG. 8 is a block diagram showing the structure of a voice recognition device in accordance with Embodiment 4 of the present invention. As shown in FIG. 8, the voice recognition device in accordance with Embodiment 4 is provided with a sound acquiring unit 1, a sound data storage unit 2, a voice recognition unit 3A, a voice recognition switching unit 4, a recognition controlling unit 5, a recognition result selecting unit 6, and a recognition result storage unit 7. In FIG. 8, the same components as those shown in FIG. 1 are designated by the same reference numerals, and the explanation of the components will be omitted hereafter.

In the voice recognition unit 3A, each of first through Mth voice recognition parts carries out a recognition process by using a voice recognition method having a different degree of recognition accuracy in a voice recognition algorithm thereof. More specifically, while the voice recognition algorithm which an Nth (N=1 to M) voice recognition part uses is not changed, the Nth voice recognition part carries out a voice recognition method having a different degree of accuracy in which a variable contributing to the degree of voice recognition accuracy is changed. For example, each of the voice recognition parts carries out the recognition process by using both a voice recognition method N(a) which has a low degree of recognition accuracy, but has a short processing time, and a voice recognition method N(b) which has a high degree of recognition accuracy, but has a long processing time. As the variable contributing to the accuracy of voice recognition, a frame period at the time of extracting a feature quantity of a voice interval, the number of mixture components in acoustic models, the number of acoustic models, or a combination of some of these variables can be provided.

A voice recognition method having a low degree of recognition accuracy is defined by the above-mentioned variable that is modified in the following way: the frame period at the time of extracting a feature quantity of a voice interval that is set to be longer than a predetermined value, the number of mixture components in acoustic models that is decreased to a value smaller than a predetermined value, the number of acoustic models that is decreased to a value smaller than a predetermined value, or a combination of some of these variables. In contrast with this, a voice recognition method having a high degree of recognition accuracy is defined by the above-mentioned variable that is modified in the following way: the frame period at the time of extracting a feature quantity of a voice interval that is set to be equal to or shorter than the above-mentioned predetermined value, the number of mixture components in acoustic models that is increased to a value equal to or larger than the above-mentioned predetermined value, the number of acoustic models that is increased to a value equal to or larger than the above-mentioned predetermined value, or a combination of some of these variables. A user is enabled to set the above-mentioned variable contributing to the degree of recognition accuracy of the voice recognition method which each of the first through Mth voice recognition parts uses where appropriate to determine the degree of recognition accuracy.

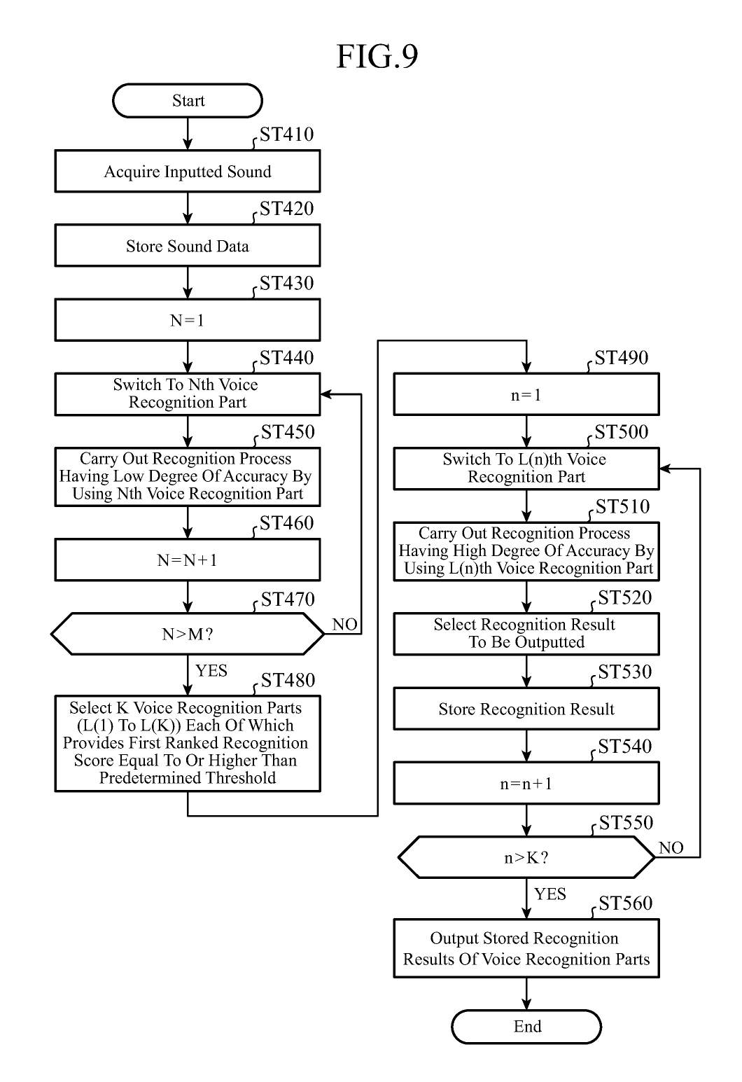

Next, the operation of the voice recognition device will be explained. FIG. 9 is a flow chart showing a flow of a voice recognition process carried out by the voice recognition device in accordance with Embodiment 4. First, the sound acquiring unit 1 performs A/D conversion on a sound received within a predetermined time interval which is inputted thereto via a microphone or the like to acquire sound data in a certain form, e.g., a PCM form (step ST410). The sound data storage unit 2 stores the sound data acquired by the sound acquiring unit 1 (step ST420).

The recognition controlling unit 5 then initializes a variable N to 1 (step ST430). The variable N can have a value ranging from 1 to M. The recognition controlling unit 5 then outputs a switching control signal to switch the voice recognition unit 3A to the Nth voice recognition part to the voice recognition switching unit 4. The voice recognition switching unit 4 switches the voice recognition unit 3A to the Nth voice recognition part according to the switching control signal from the recognition controlling unit 5 (step ST440).

The Nth voice recognition part detects a voice interval corresponding to a user's utterance from the sound data stored in the sound data storage unit 2, extracts a feature quantity of the sound data within the voice interval, and carries out a recognition process on the sound data on the basis of the feature quantity while referring to a recognition dictionary by using a voice recognition method having a low degree of recognition accuracy (step ST450). When a recognition result acquired by the recognition result selecting unit 6 is then stored in the recognition result storage unit 7, the recognition controlling unit 5 increments the variable N by 1 (step ST460), and determines whether the value of the variable N exceeds the total number M of the voice recognition parts (step ST470). When the value of the variable N is equal to or smaller than the total number M of the voice recognition parts (when NO in step ST470), the voice recognition device returns to the process of step ST440. The voice recognition device then repeats the above-mentioned processes by using the voice recognition part to which the voice recognition switching unit switches the voice recognition unit.

In contrast, when the value of the variable N exceeds the total number M of the voice recognition parts (when YES in step ST470), the recognition controlling unit 5 acquires recognition results from the Nth voice recognition part, compares a first ranked recognition score (likelihood) in the recognition scores of the recognition results with a predetermined threshold, and determines whether there are K voice recognition parts each of which provides a first ranked recognition score equal to or higher than the threshold (step ST480). As a result, the voice recognition device narrows down the first through Mth voice recognition parts to K voice recognition parts L (1) to L (K) each of which provides a first ranked recognition score equal to or higher than the threshold by using a voice recognition method having a low degree of recognition accuracy.

The recognition controlling unit 5 initializes a variable n to 1 (step ST490). n is the variable having a value ranging from 1 to K. Next, the recognition controlling unit 5 outputs a switching control signal to switch to the voice recognition part L(n) among the voice recognition parts L(1) to L(K) selected in step ST480 to the voice recognition switching unit 4. The voice recognition switching unit 4 switches the voice recognition unit 3A to the voice recognition part L(n) according to the switching control signal from the recognition controlling unit 5 (step ST500).

The voice recognition part L (n) detects a voice interval corresponding to a user's utterance from the sound data stored in the sound data storage unit 2, extracts a feature quantity of the sound data within the voice interval, and carries out a recognition process on the sound data on the basis of the feature quantity while referring to the recognition dictionary by using a voice recognition method having a high degree of recognition accuracy (step ST510). Every time when the voice recognition part L(n) finishes the recognition process, the recognition controlling unit 5 acquires recognition results acquired by the voice recognition part.

Next, the recognition result selecting unit 6 selects a recognition result to be outputted from the recognition results acquired by the Nth voice recognition part which the recognition controlling unit 5 acquires by using the same method as that according to above-mentioned Embodiment 1 (steps ST70 and ST90 of FIG. 2) (step ST520). The recognition result selecting unit 6 stores the selected recognition result in the recognition result storage unit 7 (step ST530).

When the recognition result is stored in the recognition result storage unit 7 by the recognition result selecting unit 6, the recognition controlling unit 5 increments the variable n by 1 (step ST540), and determines whether the value of the variable n exceeds the number K of the voice recognition parts selected in step ST480 (step ST550). When the value of the variable n is equal to or smaller than the number K of the voice recognition parts selected in step ST480 (when NO in step ST550), the voice recognition device returns to the process of step ST500. As a result, the voice recognition device repeats the above-mentioned processes by using the voice recognition part to which the voice recognition switching unit switches the voice recognition unit.

When the value of the variable n exceeds the number K of the voice recognition parts selected in step ST480 (when YES in step ST550), a display unit 8 outputs the recognition results acquired by the voice recognition parts L(1) to L(K) stored in the recognition result storage unit 7 (step ST130). The display unit 8 can output the recognition results in order in which the recognition results have been acquired by the voice recognition parts L(1) to L(K).

As mentioned above, in the voice recognition device in accordance with this Embodiment 4, each of the first through Mth voice recognition parts of the voice recognition unit 3A can carry out a recognition process having a different degree of accuracy, and the recognition controlling unit 5 causes each of the voice recognition parts to carry out the recognition process with a gradually increasing degree of accuracy while narrowing down the voice recognition parts each of which carries out the recognition process on the basis of the recognition scores of the recognition results acquired by the voice recognition parts. Because the voice recognition device is constructed in this way, by using, for example, a combination of a voice recognition method which has a low degree of recognition accuracy, but has a short processing time, and a voice recognition method which has a high degree of recognition accuracy, but has a long processing time, the voice recognition device carries out voice recognition by using the method having a low degree of accuracy in performing each of a plurality of voice recognition processes, and then carries out high-accuracy voice recognition in performing a voice recognition process providing a high recognition score among the plurality of voice recognition processes. As a result, because the voice recognition device does not have to carry out high-accuracy voice recognition in performing every one of all the recognition processes, thereby being able to reduce the time required to carry out the whole of the recognition processing.

### Embodiment 5

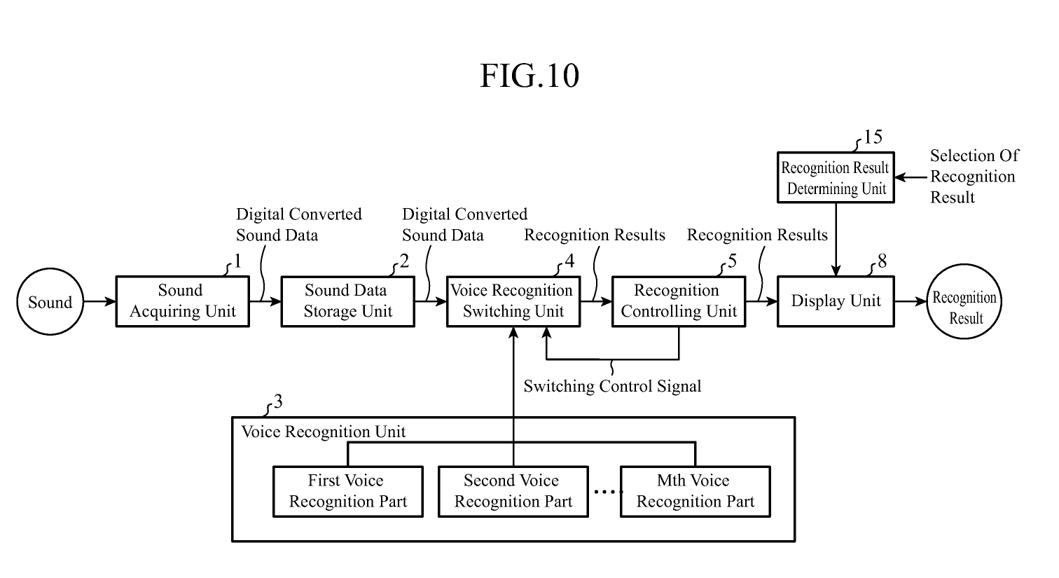

FIG. 10 is a block diagram showing the structure of a voice recognition device in accordance with Embodiment 5 of the present invention. As shown in FIG. 10, the voice recognition device in accordance with Embodiment 5 is provided with a sound acquiring unit 1, a sound data storage unit 2, a voice recognition unit 3, a voice recognition switching unit 4, a recognition controlling unit 5, and a recognition result determining unit 15. The recognition result determining unit 15 accepts a selection of a recognition result which is made by a user on the basis of candidates for recognition results displayed on a display unit 8, and determines the selected candidate for recognition result as a final recognition result. For example, the recognition result determining unit 15 displays a screen for selection of a recognition result on the screen of the display unit 8, and provides an HMI for enabling a user to select a candidate for recognition result on the basis of the screen for selection of recognition result by using an input unit, such as a touch panel, a hard key, or buttons. In FIG. 10, the same components as those shown in FIG. 1 are designated by the same reference numerals, and the explanation of the components will be omitted hereafter.

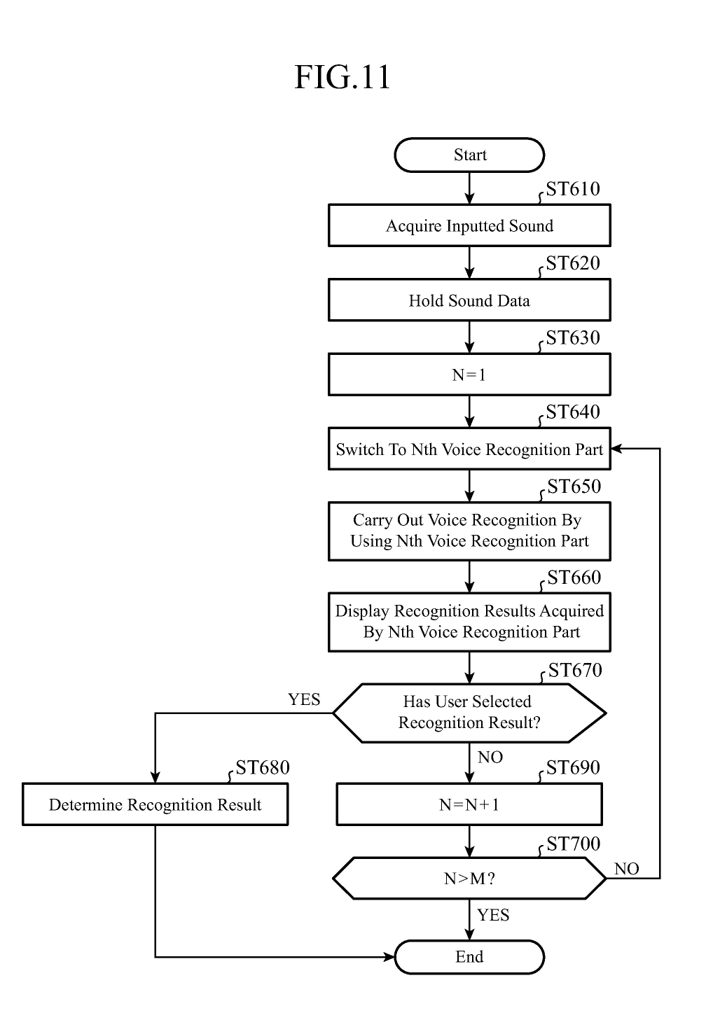

Next, the operation of the voice recognition device will be explained. FIG. 11 is a flowchart showing a flow of a voice recognition process carried out by the voice recognition device in accordance with Embodiment 5. First, the sound acquiring unit 1 performs A/D conversion on a sound received within a predetermined time interval which is inputted thereto via a microphone or the like to acquire sound data in a certain form, e.g., a PCM form (step ST610). The sound data storage unit 2 stores the sound data acquired by the sound acquiring unit 1 (step ST620).

The recognition controlling unit 5 then initializes a variable N to 1 (step ST630). The variable N can have a value ranging from 1 to M. The recognition controlling unit 5 then outputs a switching control signal to switch the voice recognition unit 3 to the Nth voice recognition part to the voice recognition switching unit 4. The voice recognition switching unit 4 switches the voice recognition unit 3 to the Nth voice recognition part according to the switching control signal from the recognition controlling unit 5 (step ST640).

The Nth voice recognition part detects a voice interval corresponding to a user's utterance from the sound data stored in the sound data storage unit 2, extracts a feature quantity of the sound data within the voice interval, and carries out a recognition process on the sound data on the basis of the feature quantity while referring to a recognition dictionary (step ST650). The recognition controlling unit 5 acquires recognition results from the Nth voice recognition part, and outputs the recognition results to the display unit 8. When receiving the recognition results from the recognition controlling unit 5, the display unit 8 displays the recognition results inputted thereto as candidates for recognition result according to a control operation by the recognition result determining unit 15 (step ST660).

When the display unit 8 displays the candidates for recognition result, the recognition result determining unit 15 enters a state in which to wait for the user's selection of a recognition result, and determines whether the user has selected a candidate for recognition result which is displayed on the display unit 8 (step ST670). When the user selects a candidate for recognition result (when YES in step ST670), the recognition result determining unit 15 determines the candidate for recognition result which has been selected by the user as a final recognition result (step ST680). As a result, the voice recognition device ends the recognition processing.

In contrast, when the user has not selected any candidate for recognition result (when NO in step ST670), the recognition controlling unit 5 increments the variable N by 1 (step ST690), and determines whether the value of the variable N exceeds the number M of the voice recognition parts (step ST700). When the value of the variable N exceeds the number M of the voice recognition parts (when YES in step ST700), the voice recognition device ends the recognition processing. In contrast, when the value of the variable N is equal to or smaller than the number M of the voice recognition parts (when NO in step ST700), the voice recognition device returns to the process of step ST640. As a result, the voice recognition device repeats the above-mentioned processes by using the voice recognition part to which the voice recognition switching unit switches the voice recognition unit.

As mentioned above, the voice recognition device in accordance with this Embodiment 5 includes the sound acquiring unit 1 for carrying out digital conversion on an inputted sound to acquire sound data; the sound data storage unit 2 for storing the sound data which the sound acquiring unit 1 acquires; the first through Mth voice recognition parts each for detecting a voice interval from the sound data stored in the sound data storage unit 2 to extract a feature quantity of the sound data within the voice interval, and each for carrying out a recognition process on the basis of the feature quantity extracted thereby while referring to the recognition dictionary; the voice recognition switching unit 4 for switching among the first through Mth voice recognition parts; the recognition controlling unit 5 for controlling the switching among the voice recognition parts by the voice recognition switching unit 4 to acquire recognition results acquired by a voice recognition part selected; and the recognition result determining unit 15 for accepting a user's selection of a recognition result from the recognition results which the recognition controlling unit 5 acquires and presents to the user, and for determining the recognition result selected by the user as a final recognition result. Because the voice recognition device is constructed in this way, the voice recognition device can determine the recognition result which the user has selected and specified as a final recognition result before carrying out all the recognition processes. Therefore, the voice recognition device can reduce the time required to carry out the whole of the recognition processing.

Although the case in which recognition results are displayed on the display unit 8 is shown in above-mentioned Embodiments 1 to 5, the presentation of the recognition results to the user is not limited to a screen display of the recognition results on the display unit 8. For example, the recognition results can be provided via voice guidance by using a sound output unit, such as a speaker.

Further, although the case in which the navigation device in accordance with the present invention is applied to a vehicle-vehicle navigation device is shown in above-mentioned Embodiment 1, the navigation device can be applied not only to a vehicle-mounted one, but also to a mobile telephone terminal or a mobile information terminal (PDA; Personal Digital Assistance). In addition, the navigation device in accordance with the present invention can be applied to a PND (Portable Navigation Device) or the like which a person carries onto a moving object, such as a car, a railroad train, a ship, or an airplane. In addition, not only the voice recognition device in accordance with above-mentioned Embodiment 1 but also the voice recognition device in accordance with any one of above-mentioned Embodiments 2 to 5 can be applied to a navigation device.

While the present invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

Because the voice recognition device in accordance with the present invention can exactly present recognition results acquired through different voice recognition processes and can achieve a reduction in the time required to carry out the recognition processing, the voice recognition device is suitable for voice recognition in a vehicle-mounted navigation device which requires a speedup in the recognition processing and the accuracy of recognition results.

### EXPLANATIONS OF REFERENCE NUMERALS

1 sound acquiring unit, 2 and 2A sound data storage unit, 3 and 3A voice recognition unit, 4 voice recognition switching unit, 5 recognition controlling unit, 6 and 6A recognition result selecting unit, 7 recognition result storage unit, 8 display unit, 9 navigation processing unit, 10 position detecting unit, 11 map database (DB), 12 input unit, 13 recognition result selection method changing unit, 14 voice interval detecting unit, 15 recognition result determining unit.

1-6. (canceled)

7. A voice recognition device comprising:
an acquiring unit that carries out digital conversion on an inputted sound to acquire sound data;
a sound data storage that stores the sound data which said acquiring unit acquires;
a plurality of voice recognizers each of that detects a voice interval from the sound data stored in said sound data storage to extract a feature quantity of the sound data within said voice interval, and each of that carries out a recognition process on a basis of said feature quantity extracted thereby while referring to a recognition dictionary;
a switch that switches among said plurality of voice recognizers;
a controller that controls the switching among the voice recognizers by said switch to acquire recognition results acquired by a voice recognizer selected; and
a selector that selects at least a recognition result satisfying a predetermined criterion from the recognition results acquired by said controller for each of said voice recognizers and presenting at least the recognition result selected together to a user.

8. A voice recognition device comprising:
an acquiring unit that carries out digital conversion on an inputted sound to acquire sound data;
a voice interval detector that detects a voice interval corresponding to a user's utterance from the sound data which said acquiring unit acquires;
a sound data storage that stores sound data about each voice interval which said voice interval detector detects;
a plurality of voice recognizers each of that extracts a feature quantity of the sound data stored in said sound data storage, and each of that carries out a recognition process on a basis of said feature quantity extracted thereby while referring to a recognition dictionary;
a switch that switches among said plurality of voice recognizers;
a controller that controls the switching among the voice recognizers by said switch to acquire recognition results acquired by a voice recognizer selected; and
a selector that selects at least a recognition result satisfying a predetermined criterion from the recognition results acquired by said controller for each of said voice recognizers and presenting at least the recognition result selected together to a user.

9. A voice recognition device comprising:
an acquiring unit that carries out digital conversion on an inputted sound to acquire sound data;
a sound data storage that stores the sound data which said acquiring unit acquires;
a plurality of voice recognizers each of that detects a voice interval from the sound data stored in said sound data storage to extract a feature quantity of the sound data within said voice interval, and each of that carries out a recognition process on a basis of said feature quantity extracted thereby while referring to a recognition dictionary;
a switch that switches among said plurality of voice recognizers;
a controller that controls the switching among the voice recognizers by said switch to acquire recognition results acquired by a voice recognizer selected; and
a determinator that selects at least a recognition result satisfying a predetermined criterion from the recognition results acquired by said controller for each of said voice recognizers and presenting at least the recognition result selected together to a user, and accepts a user's selection of a recognition result and determining the recognition result selected by the user from at least the recognition result presented to the user as a final recognition result.

10. The voice recognition device according to claim 7, wherein said voice recognition device includes a changer that accepts a specification of a selection method of selecting the recognition result to be presented to the user from the recognition results which said controller acquires, and for changing a selection method of selecting the recognition result which said selector uses according to the specified selection method.

11. The voice recognition device according to claim 7, wherein each of said plurality of voice recognizers can carry out a recognition process having a different degree of accuracy, and said controller causes each of said voice recognizers to carry out the recognition process with a gradually increasing degree of accuracy while narrowing down the voice recognizers each of which carries out the recognition process on a basis of recognition scores of their recognition results.

12. The voice recognition device according to claim 8, wherein each of said plurality of voice recognizers can carry out a recognition process having a different degree of accuracy, and said controller causes each of said voice recognizers to carry out the recognition process with a gradually increasing degree of accuracy while narrowing down the voice recognizers each of which carries out the recognition process on a basis of recognition scores of their recognition results.

13. The voice recognition device according to claim 9, wherein each of said plurality of voice recognizers can carry out a recognition process having a different degree of accuracy, and said controller causes each of said voice recognizers to carry out the recognition process with a gradually increasing degree of accuracy while narrowing down the voice recognizers each of which carries out the recognition process on a basis of recognition scores of their recognition results.

14. A navigation device including a voice recognition device according to claim 7, wherein said navigation device carries out a navigation process by using recognition results acquired by said voice recognizers.

15. A navigation device including a voice recognition device according to claim 8, wherein said navigation device carries out a navigation process by using recognition results acquired by said voice recognizers.

16. A navigation device including a voice recognition device according to claim 9, wherein said navigation device carries out a navigation process by using recognition results acquired by said voice recognizers.
